(19) United States
(12) Patent Application Publication
(10) Pub. No.: US 2011/0205434 A1
(43) Pub. Date: Aug. 25, 2011

(54) REMOTE JACK PACK

(76) Inventors: Robert Bambic, Plainfield, IL (US); Richard Lewis, Buffalo Grove, IL (US); Timothy V. Frahm, Palatine, IL (US); Moon Soo Park, Buffalo Grove, IL (US)

(21) Appl. No.: 12/710,530

(22) Filed: Feb. 23, 2010

(51) Int. Cl. H04N 3/27; H04N 5/268; H04N 5/50

(52) U.S. Cl. 348/554; 348/706; 348/731; 348/E05.097; 348/E05.057; 348/E03.049

(57) ABSTRACT

A remote jack pack has a video input jack that receives a video signal, an audio input jack that receives an audio signal, a video output that transfers the video signal to a television, an audio output that transfers the audio signal to the television, and a control output that automatically supplies control signals to the television. The control signals indicate the availability of the video and audio signals for processing by the television. The television has a tuner that supplies video and audio signals of a selected channel, a video connector that receives video from the remote jack pack, an audio connector that receives audio from the remote jack pack, a control connector that receive control signals from the remote jack pack, and a processor that is responsive to the control signals to selectively control display of the video and audio signals from the tuner and the video and audio signals from the video and audio connectors.

### TECHNICAL FIELD OF THE INVENTION

The present invention relates to a remote jack pack that is useful in remotely connecting various local video and/or audio sources to a television.

### BACKGROUND OF THE INVENTION

Televisions, such as those used in facilities like hotels and motels that accommodate guests, are connected to cables that carry a variety of television program, radio program, and/or video-on-demand channels. It is also known to use such televisions to notify guests about the activities offered or hosted by the facility. It is further known to use such televisions to offer guests various guest services such as express check out. Occasionally, games and video players coupled to the televisions are even provided by the facility so that the guests can play videos or games on the televisions.

However, all such programs, information, guest services, games, and video players are provided by the facility. Currently, guests have limited ability to connect their own equipment to the televisions provided in their accommodations. For example, guests frequently travel with personal computers, camcorders, portable games, DVD players, and MP3 players. Guests are unable to conveniently avail themselves of the enhanced viewing and/or listening experience that these televisions offer with respect to their own personal equipment.

The present invention relates to a remote jack pack that allows a user to remotely, easily, and conveniently connect user equipment to a television.

### SUMMARY OF THE INVENTION

According to one aspect of the present invention, a remote jack pack comprises a video input jack, an audio input jack, a video output, an audio output, and a control output. The video input jack is configured to receive a video signal, and the audio input jack is configured to receive an audio signal. The video output is configured to transfer the video signal to a television, and the audio output is configured to transfer the audio signal to the television. The control output is configured to automatically supply control signals to the television upon detection of a video and/or audio signal at a respective one of the video and/or audio input jacks. The control signals indicate the availability of the video and audio signals for processing by the television.

According to another aspect of the present invention, a television comprises a tuner arranged to supply video and audio signals of a selected channel, a video connector arranged to receive video from a remote jack pack, an audio connector arranged to receive audio from the remote jack pack, a control connector arranged to receive control signals from the remote jack pack, and a processor responsive to the control signals to selectively control display of the video and audio signals from the tuner and the video and audio signals from the video and audio connectors.

According to still another aspect of the present invention, a system comprises a remote jack pack and a television. The remote jack pack comprises a video input jack configured to receive a video signal, an audio input jack configured to receive an audio signal, a video output configured to transfer the video signal to the television, an audio output configured to transfer the audio signal to the television, and a control output configured to supply control signals to the television. The control signals indicate the availability of the video and audio signals for processing by the television. The television comprises a tuner arranged to supply video and audio signals of a selected channel, a video connector connected to the video output of the remote jack pack to receive the video signal from a remote jack pack, an audio connector connected to the audio output of the remote jack pack to receive the audio signal from the remote jack pack, a control connector connected to the control output of the remote jack pack to receive the control signals from the remote jack pack, and a processor responsive to the control signals to selectively control display of the video and audio signals from the tuner and the video and audio signals from the video and audio connectors.

According to yet another aspect of the present invention, a television comprises at least first, second, and third control terminals and a processor. The at least first, second, and third control terminals are arranged to receive corresponding first, second, and third control signals from a source external of the television. The processor selectively controls display of audio signals from first and second audio sources in response to only the first control signal and selectively controls display of video signals from first and second video sources in response to only the second and third control signals.

### BRIEF DESCRIPTION OF THE DRAWINGS

These and other features and advantages will become more apparent from a detailed consideration of the invention when taken in conjunction with the drawings in which:

FIG. 1 illustrates a remote jack pack connected to a television according to one embodiment of the present invention;

FIG. 2 illustrates the audio portion of the remote jack pack shown in FIG. 1;

FIG. 3 illustrates the video portion of the remote jack pack shown in FIG. 1;

FIG. 4 illustrates video and audio control signals that are coupled from the remote jack pack to the television of FIG. 1; and,

FIG. 5 illustrates an example of a television that can be used for the television of FIG. 1.

### DETAILED DESCRIPTION

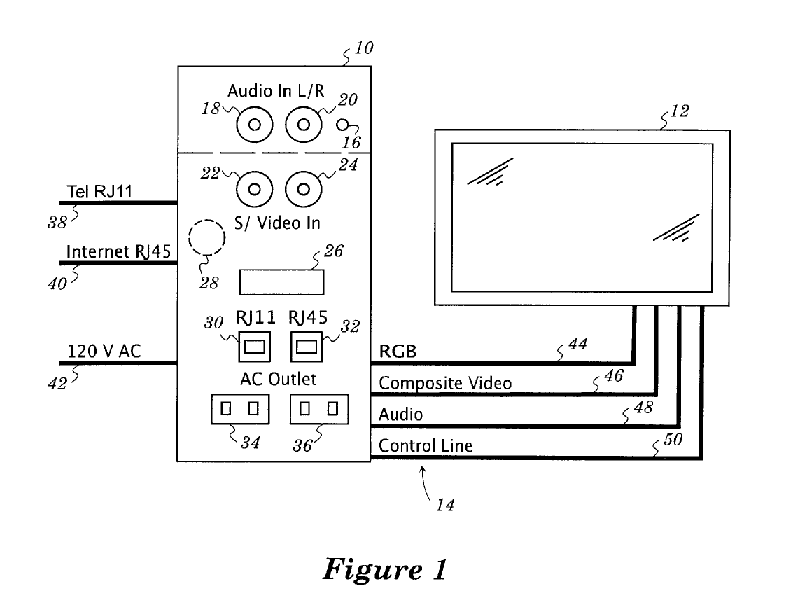

As shown in FIG. 1, a remote jack pack 10 is remotely coupled to a television 12 by electrical lines 14. The remote jack pack 10, for example, may be attached to a mounting structure such as a desk, table, or stand that is remotely located from the television 12. This mounting structure can conveniently, although not necessarily, support any of the equipment to be connected to the remote jack pack 10.

The television 12 may be an analog television such as one conforming to the NTSC standard, a digital television such as one conforming to the ATSC digital television standard, or other television that is suitably equipped to receive the electrical lines 14. The electrical lines 14 may include any number and type of electrical lines dependent upon the types of equipment to be coupled through the remote jack pack 10 to the television 12.

The remote jack pack 10 supports a 3.5 mm audio input jack 16, left and right audio input jacks 18 and 20, a super VHS video input jack 22, a composite video input jack 24, and an RGB input jack 26. A radio audio input jack 28 is capable of accepting audio signals from a radio or other device. Because the radio audio input jack 28 may be supported on the back of the remote jack pack 10, it is shown in phantom.

The 3.5 mm audio input jack 16 is capable of receiving a corresponding plug from an MP3 player, CD, or radio. Accordingly, a user can play audio from any of these sources through the speakers of the television 12.

The left and right audio input jacks 18 and 20 are capable of receiving corresponding audio left and right plugs from audio equipment, a VCR, a DVD player, etc. Accordingly, a user can play the audio portion of a video cassette or DVD or the audio from audio equipment through the speakers of the television 12.

The super VHS video input jack 22 is capable of receiving video super VHS plugs from a super VHS player or DVD player. The audio from these devices can be plugged into one of the audio jacks described above. Accordingly, a user can play super VHS video and audio on the television 12.

The RGB input jack 26 is capable of receiving a plug from a computer or set top box so that a user can play the video of a game, a DVD, etc. from a user's computer on the television 12 or the video from a set top box on the television 12. The audio from the computer or set top box can be plugged into one of the audio jacks described above.

The composite video input jack 24 is capable of receiving video from a VCR or DVD. Accordingly, a user can play the video of a video cassette or DVD on the television 12.

The remote jack pack 10 may have other jacks such as a telephone jack 30, a high speed internet connection jack 32, and AC outlets 34 and 36. Accordingly, the user can connect a computer or other equipment to the telephone jack 30 and to the high speed internet connection jack 32 and can power various equipment such as a computer by way of the AC outlets 34 and 36. For these purposes, the remote jack pack 10 interconnects the telephone jack 30 with a telephone line 38, interconnects the high speed internet connection jack 32 with a high speed internet access line 40, and supplies AC power from AC lines 42 to the AC outlets 34 and 36.

The electrical lines 14 include three RGB lines 44, a composite video line 46, two (left and right) audio lines 48, and four control lines 50. The three RGB lines 44 connect the red (R), green (G), and blue (B) signals from the RGB input jack 26 to RGB inputs of the television 12. The composite video line 46 connects the composite video signal from the composite video input jack 24 to a video input of the television 12. As explained below, the composite video line 46 also connects the super VHS video input jack 22 to a video input of the television 12. The audio lines 48 connect the audio signals from the 3.5 mm audio input jack 16, from the left and right audio input jacks 18 and 20, and from the radio audio input jack 28 to audio inputs of the television 12. The control lines 50 connect various control signals from the remote jack pack 10 to the television 12, as explained below.

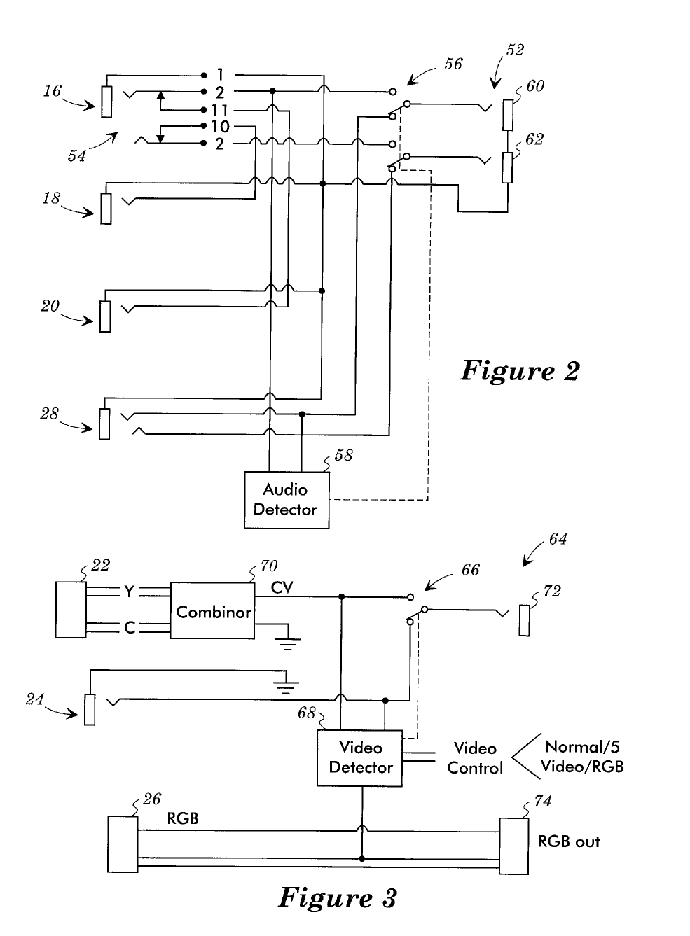

The remote jack pack 10 includes an audio portion 52 as shown in FIG. 2. The audio portion 52 of the remote jack pack 10 has the 3.5 mm audio input jack 16, the left and right audio input jacks 18 and 20, and the radio audio input jack 28 as shown. The audio portion 52 of the remote jack pack 10 further includes switches 54 and 56 and an audio detector 58. The switch 54 cooperates with the 3.5 mm audio input jack 16, and the switch 56 is controlled by the audio detector 58.

The contacts of the switch 54 respond to the insertion of an audio plug into the 3.5 mm audio input jack 16 by opening so that the inserted audio plug is connected to the switch 56 and so that the left and right audio input jacks 18 and 20 are not connected to the switch 56. At the same time, the audio detector 58 detects that there is an audio signal on the 3.5 mm audio input jack 16 and, consequently, controls the switch 56 to couple this audio signal from the 3.5 mm audio input jack 16 to left and right audio output jacks 60 and 62 of the audio portion 52 of the remote jack pack 10. The left and right audio output jacks 60 and 62 connect to the audio lines 48.

Alternatively, when an audio plug is not inserted into the 3.5 mm audio input jack 16, the contacts of the switch 54 remain in their original positions. Accordingly, audio plugs inserted into the left and right audio input jacks 18 and 20 are connected to the switch 56 and the 3.5 mm audio input jack 16 is not connected to the switch 56. At the same time, the audio detector 58 detects that there is an audio signal on the left and right audio input jacks 18 and 20 and, consequently, controls the switch 56 to couple this audio signal from the left and right audio input jacks 18 and 20 to the left and right audio output jacks 60 and 62 and then on to the audio lines 48.

When a signal is present on the radio audio input jack 28, the audio detector 58 detects that there is an audio signal on the radio audio input jack 28 and, consequently, controls the switch 56 to couple this audio signal from the radio audio input jack 28 to the left and right audio output jacks 60 and 62 and then on to the audio lines 48.

The audio detector 58, such as a threshold comparator and a microprocessor, also supplies control signals, as explained more fully below, over appropriate ones of the control lines 50 to condition the television 12 to couple its appropriate audio sources to the audio processors of the television 12.

The audio detector 58 may be arranged to resolve the contention that is created when two or more plugs are inserted into the 3.5 mm audio input jack 16, the left and right audio input jacks 18 and 20, and/or the radio audio input jack 28 during overlapping periods of time. In this case, the audio detector 58 may be arranged or programmed to select one of the contending audio inputs for supply to the left and right audio output jacks 60 and 62. For this purpose, this audio input selection may be implemented according to any desired prioritization model.

The remote jack pack 10 further includes a video portion 64 as shown in FIG. 3. The video portion 64 of the remote jack pack 10 has the super VHS video input jack 22, the composite video input jack 24, and the RGB input jack 26, as shown. The video portion 64 of the remote jack pack 10 further includes a switch 66, a video detector 68, and a combiner 70. The switch 66 is controlled by the video detector 68.

When a super VHS video plug is inserted into the super VHS video input jack 22, the combiner 70, such as a summing circuit, combines the luminance and chrominance signals of the super VHS signal into a composite video signal. The video detector 68 detects that there is a composite video signal at the output of the combiner 70 and, consequently, controls the switch 66 to couple this composite video signal from the combiner 70 to a composite video output jack 72 in the video portion 64 of the remote jack pack 10. The composite video output jack 72 connects to the composite video line 46.

When a composite video plug is inserted into the composite video input jack 24, the video detector 68 detects that there is a video signal on the composite video input jack 24 and, consequently, controls the switch 66 to couple this video signal from the composite video input jack 24 to the composite video output jack 72 and then on to the composite video line 46.

When an RGB plug is inserted into the RGB input jack 26, the resulting signal on the RGB input jack 26 is coupled directly through the remote jack pack 10 to an RGB output jack 74 and then on to the RGB lines 44.

The video detector 68, such as sync detector and a microprocessor, also supplies control signals, explained more fully below, over appropriate ones of the control lines 50 to condition the television 12 to couple its appropriate video sources to the video processors of the television 12. Assuming that the audio detector 58 and the video detector 68 have microprocessors as described above, the audio detector 58 and the video detector 68 may share the same microprocessor. These microprocessors or shared microprocessor may perform other functions, such as other switching functions, than those described herein.

The video detector 68 may be arranged to resolve the contention that is created when plugs are inserted into both the super VHS video input jack 22 and the composite video input jack 24 during overlapping periods of time. In this case, the video detector 68 may be arranged or programmed to select one of the contending video inputs for supply to the composite video output jack 72. For this purpose, this video input selection may be implement according to any desired prioritization model.

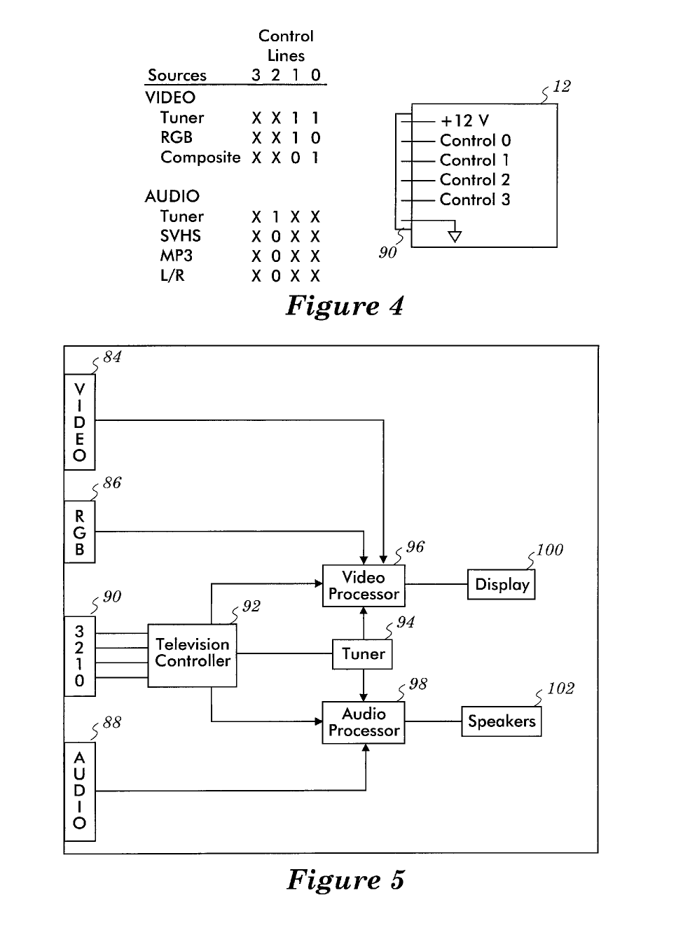

FIG. 4 illustrates the video and audio control signals that are coupled over corresponding ones of the control lines 50 to the television 12. As can be seen in FIG. 4, the television 12 has six terminals. These six terminals may be formed as one or more jacks, pins, etc. Each of these terminals is connected to a corresponding one of the control lines 50. There four control lines 50 are designated 0-3 in FIG. 4.

Thus, when the video detector 68 detects no signal on the super VHS video input jack 22, the RGB input jack 26, and the composite video input jack 24, it drives the control lines 0 and 1 high. In response to these control signals, the television 12 supplies the video output from its own tuner to its video processor for display to the user. A signal on control line 3 is not controlling as indicated by the x, and a signal on control line 2 controls audio as discussed below.

When the video detector 68 detects an RGB signal on the RGB input jack 26, it drives the control line 0 low and the control line 1 high. In response to these control signals, the television 12 supplies the RGB video on the RGB lines 44 to its video processor for display to the user. Again, a signal on control line 3 is not controlling as indicated by the x, and a signal on control line 2 controls audio as discussed below.

When the video detector 68 detects a composite video signal either on the composite video input jack 24 or at the output of the combiner 70, it drives the control line 0 high and the control line 1 low. In response to these control signals, the television 12 supplies the composite video on the composite video line 46 to its video processor for display to the user. Still again, a signal on control line 3 is not controlling as indicated by the x, and a signal on control line 2 controls audio as discussed below.

When the audio detector 58 detects no signal on the 3.5 mm audio input jack 16, the left and right audio input jacks 18 and 20, and the radio audio input jack 28, it drives the control line 3 high. In response to this control signal, the television 12 supplies the audio output from its own tuner to its audio processor for supply to its speakers. Any signal on control line 3 is not controlling, and signals on control lines 0 and 1 control video, as discussed above.

When the audio detector 58 detects an audio signal on the 3.5 mm audio input jack 16, the left and right audio input jacks 18 and 20, or the radio input jack 28, it drives the control line 0 low. In response to this control signal, the television 12 supplies the audio on the audio lines 48 to its audio processor for supply to its speakers. Again, any signal on control line 3 is not controlling, and signals on control lines 0 and 1 control video, as discussed above.

An exemplary television 80 is shown in FIG. 5 and can be used for the television 12. The exemplary television 80 includes a cabinet 82 on which are mounted a video connector 84, an RGB connector 86, an audio connector 88, and a control connector 90. The control connector 90 may comprise one or more jacks, pins, an RS232 connector, etc. The video connector 84 is connected to the composite video line 46, the RGB connector 86 is connected to the RGB lines 44, the audio connector 88 is connected to the audio lines 48, and the control connector 90 is connected to the control lines 50. The video connector 84, the RGB connector 86, and the audio connector 88 may be corresponding jacks, terminals, pins, etc.

The exemplary television 80 also includes a television controller 92, a tuner 94, a video processor 96, an audio processor 98, a video display 100, and audio speakers 102. The television controller 92, for example, may comprise a microprocessor and controls the tuner 94 in accordance with a channel selected by a user.

When the television controller 92 detects x111 control signals on the control connector 90, the television controller 92 controls the video processor 96 and the audio processor 98 to process the video and audio from the tuner 94. When the television controller 92 detects x010 control signals on the control connector 90, the television controller 92 controls the video processor 96 to process the video from the RGB connector 86 and controls the audio processor 98 to process the audio from the audio connector 88. When the television controller 92 detects x001 control signals on the control connector 90, the television controller 92 controls the video processor 96 to process the video from the video connector 84 and controls the audio processor 98 to process the audio from the audio connector 88.

As can be seen from FIG. 4, other combinations are possible. For example, if the television controller 92 detects x011 control signals on the control connector 90, the television controller 92 controls the video processor 96 to process the video from the tuner 94 and controls the audio processor 98 to process the audio from the audio connector 88.

As further shown in FIG. 5, the video processed by the video processor 96 is supplied to the video display 100, and the audio processed by the audio processor 98 is supplied to the audio speakers 102.

Certain modifications of the present invention have been discussed above. Other modifications of the present invention will occur to those practicing in the art of the present invention. For example, the remote jack pack 10 is shown with various audio and video input jacks. However, the remote jack pack 10 may be provided with audio and video input jacks that allow connection to sources in addition to and/or other than an MP3 player, a DVD, a VCR, and a super VHS as described above.

Moreover, as described above, the remote jack pack 10 includes the left and right audio output jacks 60 and 62, a composite video output jack 72, and an RGB output jack 74 to connect audio and video signals over the RGB lines 44, the composite video line 46, and the audio lines 48 to the television 12. Instead, the RGB lines 44, the composite video line 46, and the audio lines 48 may be directly wired into the circuits within the remote jack pack 10.

As can be seen from FIG. 4, not all of the control lines 50 are used to carry a control signal. Therefore, the control line not used as indicated by FIG. 4 may be used by the remote jack pack 10 for other purposes, may be deleted, or may be retained for expansion purposes.

The exemplary television 80 as described above is provided with a control connector 90 that is coupled to the television controller 92 of the exemplary television 80. The television controller 92, accordingly, detects the state of the control lines 50, as also described above. As also described above, the control connector 90 may be an RS 232 connection such as for those televisions that are equipped with RS 232 ports by the manufacturer.

Accordingly, the description of the present invention is to be construed, as illustrative only and is for the purpose of teaching those skilled in the art the best mode of carrying out the invention. The details may be varied substantially without departing from the spirit of the invention, and the exclusive use of all modifications which are within the scope of the appended claims is reserved.

1-55. (canceled)

56. A remote jack pack comprising:
a video input jack configured to receive a video signal;
an audio input jack configured to receive an audio signal;
a video output configured to transfer the video signal to a television;
an audio output configured to transfer the audio signal to the television; and,
a control output configured to automatically supply control signals to the television upon detection of a video and/or audio signal at a respective one of the video and/or audio input jacks, wherein the control signals instruct the television to select the video signal on the video output and/or the audio signal on the audio output for processing by the television.

57. The remote jack pack of claim 56 wherein the control output is configured to automatically supply control signals to the television so as to instruct the television to display video from a tuner of the television and to reproduce audio provided by the audio signal at the audio output of the remote jack pack in response to detection of an audio signal at the audio input jack and to otherwise reproduce audio from the tuner.

58. The remote jack pack of claim 56 further comprising an audio detector, wherein the audio detector senses the presence of the audio signal on the audio input jack so as to provide a first of the control signals on the control output, and wherein the first control signal indicates the availability of the audio signal on the audio output for processing by the television.

59. The remote jack pack of claim 58 wherein the audio input jack comprises a first audio input jack, wherein the remote jack pack further comprises a second audio input jack, wherein the audio detector is responsive to the presence of the audio signal on the first audio input jack so as to couple the audio signal from the first audio input jack to the audio output, and wherein the audio detector is responsive to the presence of the audio signal on the second audio input jack so as to couple the audio signal from the second audio input jack to the audio output.

60. The remote jack pack of claim 56 further comprising a video detector, wherein the video detector senses the presence of the video signal on the video input jack so as to provide a first of the control signals on the control output, and wherein the first control signal indicates the availability of the video signal on the video output for processing by the television.

61. The remote jack pack of claim 60 wherein the video input jack comprises a first video input jack, wherein the remote jack pack further comprises a second video input jack, wherein the video detector is responsive to the presence of the video signal on the first video input jack so as to couple the video signal from the first video input jack to the video output, and wherein the video detector is responsive to the presence of the video signal on the second video input jack so as to couple the video signal from the second video input jack to the video output.

62. The remote jack pack of claim 60 further comprising an audio detector, wherein the audio detector senses the presence of the audio signal on the audio input jack so as to provide a second of the control signals on the control output, and wherein the second control signal indicates the availability of the audio signal on the audio output for processing by the television.

63. The remote jack pack of claim 56 wherein the audio input jack comprises a first audio input jack, wherein the audio signal comprises a first audio signal, and wherein the remote jack pack further comprises:
a second audio input jack configured to receive a second audio signal;
a switch having a first state coupling the first audio input jack to the audio output and a second state coupling the second audio input jack to the audio output; and,
an audio detector, wherein the audio detector is responsive to the presence of the first audio signal on the first audio input jack so as drive the switch to the first state, wherein the audio detector is alternatively responsive to the presence of the second audio signal on the second audio input jack so as to drive the switch to the second state, wherein the audio detector is further responsive to the presence of the first and second audio signals on the corresponding first and second audio input jacks so as to provide a first of the control signals on the control output, and wherein the first control signal indicates the availability of the first audio signal on the audio output for processing by the television when the switch is in the first state and alternatively indicates the availability of the second audio signal on the audio output for processing by the television when the switch is in the second state.

64. The remote jack pack of claim 56 wherein the video input jack comprises a first video input jack, wherein the video signal comprises a first video signal, and wherein the remote jack pack further comprises:
a second video input jack configured to receive a second video signal;
a switch having a first state coupling the first video input jack to the video output and a second state coupling the second video input jack to the video output; and,
a video detector, wherein the video detector is responsive to the presence of the first video signal on the first video input jack so as drive the switch to the first state, wherein the video detector is alternatively responsive to the presence of the second video signal on the second video input jack so as to drive the switch to the second state, wherein the video detector is further responsive to the presence of the first and second video signals on the corresponding first and second video input jacks so as to provide a first of the control signals on the control output, and wherein the first control signal indicates the availability of the first video signal on the video output for processing by the television when the switch is in the first state and alternatively indicates the availability of the second video signal on the video output for processing by the television when the switch is in the second state.

65. The remote jack pack of claim 56 wherein the audio input jack comprises a first audio input jack, wherein the audio signal comprises a first audio signal, and wherein the remote jack pack further comprises:
a second audio input jack configured to receive a second audio signal; and,
an audio detector, wherein the audio detector is responsive to the presence of the first audio signal on the first audio input jack so as couple the first audio signal to the audio output, wherein the audio detector is responsive to the presence of the second audio signal on the second audio input jack so as couple the second audio signal to the audio output, and wherein the audio detector is arranged to implement a prioritization model so as to couple one of the first and second audio signals to the audio output when the first and second audio signals are present on the first and second audio input jacks at the same time.

66. The remote jack pack of claim 56 wherein the video input jack comprises a first video input jack, wherein the video signal comprises a first video signal, and wherein the remote jack pack further comprises:
a second video input jack configured to receive a second video signal; and,
a video detector, wherein the video detector is responsive to the presence of the first video signal on the first video input jack so as couple the first video signal to the video output, wherein the video detector is responsive to the presence of the second video signal on the second video input jack so as couple the second video signal to the video output, and wherein the video detector is arranged to implement a prioritization model so as to couple one of the first and second video signals to the video output when the first and second video signals are present on the first and second video input jacks at the same time.

67. A remote jack pack comprising:
a video input jack configured to receive video;
an audio input jack configured to receive audio;
a video output configured to transfer the video to a television;
an audio output configured to transfer the audio to the television; and,
a control output configured to automatically supply control signals to the television upon detection of at least one of the video at the video input jack and the audio at the audio input jack, wherein at least some of the control signals instruct the television to simultaneously display video from an internal tuner of the television and reproduce the audio at the audio output of the remote jack pack.

68. The remote jack pack of claim 67 wherein others of the control signals instruct the television to display the video at the video output of the remote jack pack and to reproduce the audio at the audio output of the remote jack pack.

69. The remote jack pack of claim 68 wherein yet others of the control signals instruct the television to display video from the tuner of the television and to reproduce audio from the tuner of the television.

70. A remote jack pack comprising:
a video input jack configured to receive video;
an audio input jack configured to receive audio;
a video output configured to transfer the video to a television;
an audio output configured to transfer the audio to the television; and,
a control output configured to automatically supply control signals to the television upon detection of at least one of the video at the video input jack and the audio at the audio input jack, wherein at least some of the control signals instruct the television to simultaneously reproduce audio from an internal tuner of the television and display the video at the video output of the remote jack pack.

71. The remote jack pack of claim 70 wherein others of the control signals instruct the television to reproduce the audio at the audio output of the remote jack pack and to display the video at the video output of the remote jack pack.

72. The remote jack pack of claim 70 wherein yet others of the control signals instruct the television to display video from the tuner of the television and to reproduce audio from the tuner of the television.
